(19) United States
(12) Patent Application Publication
(10) Pub. No.: US 2025/0306400 A1
(43) Pub. Date: Oct. 2, 2025

(54) SPECTACLE LENSES FOR REDUCING MYOPIA PROGRESSION

(71) Applicant: Rodenstock GmbH, Muenchen (DE)

(72) Inventors: Yohann Bénard, Muenchen (DE); Gregor Esser, Muenchen (DE); Anne Seidemann, Muenchen (DE); Helmut Altheimer, Baisweil-Lauchdorf (DE); Dietmar Uttenweiler, Icking (DE); Stephan Trumm, Muenchen (DE); Reiner Beck, Bayreuth (DE)

(21) Appl. No.: 18/864,436

(22) PCT Filed: May 12, 2023
(86) PCT No.: PCT/EP2023/062695

§ 371 Date: Nov. 8, 2024

(30) Foreign Application Priority Data
May 12, 2022 (DE) 10 2022 111 995.5

(51) Int. Cl. G02C 7/06

(52) U.S. Cl. CPC G02C 7/066; G02C 2202/24

(57) ABSTRACT

A spectacle lens and to a method for producing such a lens, the spectacle lens comprising: a central main viewing region, with substantially constant optical power; an effect region around the central main viewing region, wherein the effect region has microstructures at least in part, said microstructures in the effect region bringing about an at least partially higher optical power than the optical power in the central main viewing region and/or at least partly a contrast reduction; and a peripheral region outside the effect region with a substantially constant optical power.

### TECHNICAL FIELD

The invention relates to a spectacle lens with at least one specially shaped peripheral region with deviating optical properties for improving long-term wearing comfort with simultaneously improved peripheral perception.

### BACKGROUND

Particularly in the case of spectacle lenses for the correction of myopia, the often significant tendency for myopia to progress means that the wearing comfort of spectacle lenses once fitted, and therefore also the satisfaction of the spectacle wearer and the tolerance of the spectacles, decrease again after a short time.

In general, myopia is increasing dramatically worldwide, especially in Asia. The WHO estimates that over 50% of all people will be myopic by 2050. As an individual's myopia increases, the risk of associated eye diseases such as retinal detachment, glaucoma, cataracts and macular degeneration also increases dramatically. There is therefore great interest in slowing down the increase in myopia. There are several approaches to slowing down the progression of myopia with optical aids (vision aids). However, what all these approaches have in common is that they are very complex and costly and also quite inflexible when it comes to adapting to rapidly changing circumstances (e.g. changes in the prescription of spectacles, demands on the visual system).

To date, various optical effects relating to the tolerability and comfort of ophthalmic lenses, in particular spectacle lenses, have been investigated with regard to their influence on myopia and/or hyperopia and progression or development thereof depending on the optical and physiological mechanisms that are intended to explain or slow down progression or advancement, in particular deterioration. The existing approaches are substantially based on imaging the image in front of the retina, as this is intended to slow down the length growth of the eye. It has been shown that it is sufficient if this only occurs in the periphery of the retina.

One possible approach is the use of bifocal lenses and/or progressive lenses (PAL). On the one hand, by way of the addition, a region is imaged in front of the retina in the peripheral region when looking into the distance and, on the other hand, the image is not imaged behind the retina when looking up close, at least if accommodation is insufficient. This works better in children with accommodation insufficiency and/or convergence excess. However, with such approaches, acceptable results are only achieved in a smaller group with convergence excess. However, bifocal lenses are not desirable, especially for children, at least for cosmetic reasons.

Another approach is based on special PALs (or radially symmetrical PALs) with a central focussing effect and a peripheral addition (e.g. DE 10 2009 053 467 A1).

PALs, as in these two approaches, have regions with large aberrations. Furthermore, the quality of peripheral vision and also of foveal vision when looking through the periphery of the lenses is greatly reduced by the aberrations. If high demands are placed on the visual system (e.g. in road traffic), this can only be solved with a second pair of single vision spectacles. This further increases the effort and costs when changing the prescription. The acceptance of such solutions is therefore often low.

Other approaches are based on special contact lenses, for example. For example, progressive contact lenses with a higher plus effect in the periphery than in the central region have been investigated. In practice, however, this also impairs foveal vision. In addition, a new lens has to be produced at great expense if the power is changed. Furthermore, handling and reliability are limited in the case of children. This is particularly true for young children, and the fact that the greatest effect is actually achieved if measures to slow down myopia are started at an early age makes things even more difficult.

Another approach with contact lenses utilises so-called Ortho-K contact lenses, which are worn overnight and deform the cornea. This is intended to correct the myopia centrally and also create a plus effect in the periphery (compared to centrally). However, each contact lens is also a special requirement here and a new lens must also be produced at great expense, e.g. in the case of a new prescription. Furthermore, the effects of corneal deformation on the metabolism and structure of the cornea are unclear, especially in young children.

The problem for spectacle wearers resulting from the progression of myopia is the steadily decreasing wearing comfort of spectacles once they have been fitted. The object of the present invention is therefore to improve the lasting compatibility of spectacles and thus to achieve long-term wearing comfort economically.

### SUMMARY

According to the invention, this object is achieved by a spectacle lens having the features specified in the independent claims. Preferred embodiments are the subject of the dependent claims.

Thus, in one aspect, the invention relates to a spectacle lens which comprises:
a central main viewing region, with substantially constant optical power and preferably a substantially constant contrast; and
a particularly substantially annular effect region around the central main viewing region, wherein the effect region has microstructures at least in part, said microstructures in the effect region bringing about
   an at least partially higher optical power than the optical power in the central main viewing region (i.e. an at least partially stronger positive dioptric power than the dioptric power in the central main viewing region—in the following, this difference is also referred to as a “positive dioptric additive power”) and/or
   at least partly a contrast reduction compared to the central main viewing region.

Particularly preferably, the spectacle lens comprises in one aspect a peripheral region, in particular a substantially annular peripheral region outside the effect region with a substantially constant optical power.

In particular, said microstructures are located only within the (annular) effect region, while both the central main viewing region and the (annular) peripheral region, which is preferably additionally provided, are preferably free of these microstructures or at least no increased optical power and/or no contrast reduction is brought about there. An important aspect of the innovation in this context is therefore not least the positive dioptric additive power and/or the contrast reduction and its distribution over the spectacle lens.

In any case, however, the microstructures do not produce the same effect over the entire surface, i.e. in all viewing points of the spectacle lens. This means that no or only a slight positive dioptric additive power is generated or no or only a slight contrast reduction is achieved, particularly in the central main viewing region (or in the peripheral region). This ensures that the spectacle lens still has the dioptric power intended for the user with the spectacle lens (in particular based on an individual prescription effect) in the central main viewing region as well as in the peripheral region and that the spectacle wearer can continue to have substantially unchanged central sharp vision with the spectacle lens and preferably can perceive peripheral movements well at the same time.

Only in the effect region does the positive dioptric additive power of the microstructures compared to the central main viewing region produce an optical imaging in front of the retina of the spectacle wearer and/or at least prevent a sharp imaging of the mid-peripheral vision from being focussed behind the retina by reducing the contrast, thus attenuating a stimulus for length expansion or length growth of the eye in question. Thus, it has been found that the spectacle lens according to the invention in particular prevents an imaging of the mid-peripheral visual range behind the retina from being focussed, which causes a stimulus for length growth of the eye. The attenuation of the stimulus for length growth thus also attenuates a short-term myopic progression of the eye, which conventionally often leads to a loss of comfort when wearing the spectacle lens.

A spectacle lens according to the invention improves the lasting compatibility of spectacles and achieves long-term wearing comfort. In this way, obstacles and dangers in the (distant) peripheral visual range are also perceived as well as possible by the spectacle wearer, at least in a way that is as familiar or as reliable as possible for the user. On the one hand, this ensures high long-term compatibility of the spectacle lens and a comfortable wearing experience, and on the other hand, a high level of safety for the user.

Thus, in one aspect, the invention provides for using such a spectacle lens for a non-therapeutic purpose to improve tolerance and comfort when using spectacle lenses over a long period of time. In one aspect, the invention avoids undesirable deterioration of vision (myopia) of an eye as caused by conventional lenses (e.g. spectacle lenses). In one aspect, the invention relates in particular to a spectacle lens with a negative dioptric power in the central main viewing region. Thus, especially in the case of an already existing myopia of an eye, which is compensated for by a spectacle lens with a negative dioptric power in the central main viewing region, the long-term maintenance of comfort when wearing this spectacle lens is achieved particularly clearly. Against this background, the invention thus relates in a further aspect in particular to a non-therapeutic use of a spectacle lens proposed here for (non-therapeutic) reduction of the progression of myopia.

Preferably, the substantially constant optical power in the peripheral region substantially corresponds to the substantially constant optical power in the central main viewing region. Preferably, the variations of the optical power within the central main viewing region and/or within the peripheral region are in a range of not more than about 1 dpt, preferably not more than about 0.5 dpt, most preferably not more than about 0.25 dpt. Particularly preferably, the optical power in the central main viewing region and in the peripheral region also deviate from each other by no more than about 1.5 dpt, preferably no more than about 1 dpt, even more preferably no more than about 0.5 dpt, most preferably no more than about 0.25 dpt.

Preferably, the optical power brought about by the microstructures in the effect region (i.e. the optical power of the spectacle lens resulting in the effect region with the aid of the microstructures) is at least about 1 dpt, even more preferably at least about 2 dpt, most preferably at least about 3 dpt higher than the optical power in the central main viewing region. In other words, the positive dioptric additive power (i.e. the additional optical power) is preferably at least about 1 dpt, more preferably at least about 2 dpt, most preferably at least about 3 dpt. Alternatively or additionally, the optical power brought about by the microstructures in the effect region is preferably at most about 10 dpt, even more preferably at most about 5 dpt, most preferably at most about 4 dpt higher than the optical power in the central main viewing region. In other words, the positive dioptric additive power is preferably at most about 10 dpt, even more preferably at most about 5 dpt, most preferably at most about 4 dpt.

The resulting peripheral defocussing in the mid-peripheral visual range towards an imaging in front of the retina results in a particularly efficient attenuation of a stimulus for length growth of the eye. Both larger and smaller values of the positive dioptric additive power of the microstructures tend to continue to tolerate an existing tendency for the eye to grow in length and thus to attenuate it less effectively. This means that with lower values of the positive dioptric additive power in the effect region, correct or possibly even slightly excessive accommodation in the central main viewing region still results in the mid-peripheral visual range being partially in focus behind the retina and thus a stimulus for length growth of the eye is hardly or not at all suppressed. With larger values of the positive dioptric additive power in the effect region, however, the mid-peripheral visual range is already perceived so blurred that the effective influence on length growth is greatly reduced, as the eye no longer perceives any significant difference between an image in front of or behind the retina.

In a preferred embodiment, the optical power increase brought about by the microstructures, i.e. the positive dioptric additive power, varies along at least one meridian of the spectacle lens through a centre of the central main viewing region by at least about 10%, preferably at least about 25%, even more preferably at least about 50%, most preferably at least about 75% or even at least about 90% of the maximum absolute value of the optical power increase brought about by the microstructures. This means that the increase in optical power brought about by the microstructures within the effect region is not the same everywhere. For example, in the case of microlenses as microstructures, the microlenses can have different surface curvatures in order to achieve different optical power values. In this embodiment, it is therefore particularly preferable if the dioptric power along this (at least one) meridian from the centre to the periphery of the spectacle lens passes through at least one local minimum within the effect region. It is also, but preferably, possible to allow the resulting optical power in the transition from the central main viewing region to the effect region and/or the resulting optical power in the transition from the effect region to the peripheral region to run substantially continuously, i.e. without a distinct step. It is particularly preferable to adapt the optical power variation to an individual measurement of a peripheral eye length.

Preferably, the optical power brought about by the microstructures along a horizontal meridian of the spectacle lens through a centre of the central main viewing region has a temporal maximum in a region in which the meridian intersects the effect region temporally from the central main viewing region and a nasal maximum in a region in which the meridian intersects the effect region nasally from the central main viewing region, such that the nasal maximum is greater than the temporal maximum, preferably greater by about 0.5 dpt to about 1 dpt. In other words, the maximum value of the positive dioptric additive power along a horizontal meridian is greater nasally from the central main viewing region than temporally from the central main viewing region. It has been found that this asymmetry in the horizontal course of the positive dioptric additive power is particularly efficient and often improves long-term wearing comfort. This could be explained by the fact that the eye length to the retina in the region temporal to the foveal region is often slightly smaller than at the same distance nasal to the foveal region.

Preferably, alternatively or additionally, the optical power brought about by the microstructures along a vertical meridian of the spectacle lens through a centre of the central main viewing region has a lower maximum in a region in which the meridian intersects the effect region below the central main viewing region and an upper maximum in a region in which the meridian intersects the effect region above the central main viewing region, such that the upper maximum is greater than the lower maximum, preferably greater by about 0.5 dpt to about 1 dpt. In other words, the maximum value of the positive dioptric additive power along a vertical meridian is greater above the central main viewing region than below the central main viewing region. It has been found that this asymmetry in the vertical course of the positive dioptric additive power is particularly efficient and often improves long-term wearing comfort. This could be explained by the fact that the eye length to the retina in the region below the foveal region is often slightly smaller than at the same distance above the foveal region.

In a particularly preferred embodiment, the distribution of the positive dioptric additive power is adjusted individually (in particular based on an individual measurement). For this purpose, the eye can be examined with a device with the aid of which central and peripheral biometric data can be measured or derived (e.g. an optical biometer, or the DNEye @Scanner 2 from Rodenstock). In particular, the central and peripheral eye length and/or the refraction of the eye, objective and/or subjective, central and/or peripheral, can be determined as biometric data. The peripheral data can be measured nasally and/or temporally and/or superiorly (light incidence from above) and/or inferiorly (light incidence from below). The eccentricity of the peripheral measurement can lie in particular in the range from 5° to 40°, preferably in the range from about 10° to about 20°. The measurement can also be carried out at several eccentricities in order to obtain an individual curve.

Preferably at least 2, more preferably at least 5 data points are determined, with at least one central and preferably one, or more preferably 4 peripheral angles of light incidence. These biometric data can be used alone or combined with other non-biometric parameters to determine an optimal distribution of the positive dioptric additive power. The non-biometric parameters may include the age of onset of myopia or the rate of progression of myopia to date.

This data are used to adjust the optical power of the microstructures locally, depending on the local eye length and/or refraction. For example, if the temporal eye length becomes smaller than the nasal eye length, the average optical power of the temporal microstructures is preferably chosen to be more positive than the average optical power of the nasal microstructures. In the case of measurements at several eccentricities, the course of the optical power of the microlenses is preferably adjusted locally so that the resulting focal point is always (preferably, where possible, substantially at the same distance) in front of the peripheral retina.

More particularly, in one aspect, the invention thus provides a method for individually calculating or producing a spectacle lens in one of the embodiments described herein for an eye of a user, said method comprising:
providing user data that define at least one central eye length and/or a central refraction (i.e. an eye length or refraction of the user at a central (foveal) incidence of light) and at least one peripheral eye length and/or a peripheral refraction (i.e. an eye length or refraction of the user at a peripheral incidence of light which deviates from the central one by a peripheral angle/eccentricity) of the eye;
determining a value of a target additive power from a value of a baseline additive power and the difference of the central eye length and the at least one peripheral eye length; and
calculating or producing the spectacle lens in such a way that the microstructures in the effect region at least partially bring about an optical power higher by the target additive power than the optical power in the central main viewing region.

An angle in the range from about 5° to about 40°, in particular in the range from about 10° to about 30°, is used as the peripheral angle (eccentricity).

Preferably, the user data define a plurality of peripheral eye lengths for at least partially horizontally and/or vertically different light incidence directions, wherein the method comprises:
determining a respective value of the target additive power for each of the light incidence directions on the basis of the value of the baseline additive power and the respective difference of the central eye length and the respective peripheral eye length;
determining a point of light transmission through the spectacle lens for each of the light incidence directions; and
calculating or producing the spectacle lens in such a way that the microstructures in the light transmission points bring about an optical power that is higher than the optical power in the central main viewing region by the respective target additive power.

Preferably, a positive dioptric additive power is defined as the baseline additive power, which in particular establishes a defined (preferably substantially constant) distance of the sharp image in front of the retina of the eye over the entire effect region (or at least over the largest part of the effect region). In order to keep this distance as constant as possible over the range of (average) peripheral vision (i.e. outside the central main viewing region) (even with local variation of the peripheral eye length), the angle-dependent eye length is also taken into account in addition to this baseline additive power. This means that the target additive power can vary locally and individually, wherein the otherwise fixed baseline additive power determines the preferably substantially constant distance of the imaging in front of the retina.

In a preferred embodiment, the effect region comprises at least one inner effect region, preferably directly adjacent to (and in particular at least partially surrounding) the central main viewing region, with microstructures which bring about the optical power that is at least partially higher than the optical power in the central main viewing region and/or the contrast reduction. In addition, the effect region in this embodiment preferably comprises at least one outer effect region with microstructures which bring about the optical power that is at least partially higher than the optical power in the central main viewing region and/or the contrast reduction. It is possible here that the microstructures in the inner and outer effect regions produce the same type and size of effect (i.e. a dioptric additive power in both cases and/or a contrast reduction in both cases). However, it is also possible for the microstructures in the inner and outer effect regions to differ from each other in terms of type and/or size.

Furthermore, in this embodiment, the effect region preferably comprises at least one intermediate region without microstructures between the inner and outer effect region or with microstructures which produce a lower optical power or a lower contrast reduction than the microstructures in the inner and in the outer effect region. Thus, at least the inner and outer effect regions at least partially have microstructures which bring about the at least partially higher optical power than the optical power in the central main viewing region; and/or at least partially bring about the contrast reduction. Preferably, the intermediate region does not have such a higher optical power or contrast reduction.

Thus, the effect region preferably has a particularly annular inner effect region and a particularly annular outer effect region, which are at least partially separated from each other by a particularly annular intermediate region, wherein the intermediate region has a lower positive dioptric additive power or a lower contrast reduction than the inner and outer effect regions. The inner effect region forms a preferably annular region, which is closer to the central main viewing region than the outer effect region, or which is directly adjacent to the central region. The inner effect region is preferably surrounded by the intermediate region, which in turn is further away from the central main viewing region than the inner effect region. Further towards the periphery, the intermediate region is surrounded by the outer effect region. While the inner and outer effect regions preferably have the positive dioptric additive power and/or (greater) contrast reduction compared to the central region, the intermediate region preferably has a smaller positive dioptric additive power or a smaller contrast reduction than the inner and outer effect regions or substantially no positive dioptric additive power or no contrast reduction. Preferably, the positive dioptric additive power in the intermediate region is not greater than about 1 dpt compared to the central region, even more preferably not greater than about 0.5 dpt, most preferably not greater than about 0.25 dpt.

The central main viewing region preferably comprises a circular area having a radius of at least about 3 mm, preferably at least about 5 mm, more preferably at least about 8 mm. In other words, this means that the central main viewing region has a size and shape such that such a circular area with the specified radii is completely contained therein. Alternatively or additionally, the central main viewing region preferably lies within a circular area having a radius of at most about 25 mm, preferably at most about 20 mm, even more preferably at most about 15 mm, most preferably at most about 10 mm. The central main viewing region can be substantially circular. Otherwise, however, the central region does not have to be exactly circular. It is also possible to provide an elliptical or generally oval shape as the central region.

This dimensioning of the central main viewing region (substantially) without a dioptric additive power ensures that a spectacle lens continues to allow good central vision with undistorted sharpness. At the same time, the positive dioptric additive power provided in the mid-peripheral range moves far enough into the centre of the field of vision to have an effective influence on the length growth of the eye.

The optional peripheral region preferably lies in particular completely outside a circular area with a radius of at least about 20 mm, preferably at least about 25 mm, particularly preferably at least about 30 mm, even more preferably at least about 35 mm, most preferably at least about 40 mm. Alternatively or additionally, the effect region 32 lies preferably in particular completely within a circular area with a radius of at most about 45 mm, preferably at most about 40 mm, particularly preferably at most about 35 mm, even more preferably at most about 30 mm, most preferably at most about 25 mm.

When using an intermediate region (substantially) without a dioptric additive power or with only a slight dioptric additive power between an inner and an outer effect region as already described, it is particularly preferable if the intermediate region is arranged within an annular region around a centre of the spectacle lens or the central main viewing region, which lies between an inner boundary circle with a radius of approximately 15 mm and an outer boundary circle with a radius of approximately 30 mm. In particular, a centre point (e.g. geometric centre of gravity or centre of an inscribed circle) of the central main viewing region (free from the additive power or contrast reduction) can serve as the centre. In particular, the (annular) intermediate region has a (ring) width of no more than about 10 mm in the radial direction.

The intermediate region thus ensures that part of the mid-peripheral visual range is imaged on the retina as sharply as the central visual range and, if necessary, the (distant) peripheral range. It has been found that this is particularly efficient for the reliable perception of movements. However, the combination of the inner and outer effect regions also ensures that a completely sharp image behind the retina is avoided, thereby attenuating the stimulus for the eye to grow in length. This in turn improves the long-term wearing comfort of the spectacles. The combination of the effects of reliable perception of movement (over the central visual range, part of the mid-peripheral visual range and the distant peripheral visual range) and long-term wearing comfort is even significantly greater when using the intermediate region described without dioptric additive power (or with reduced dioptric additive power) or without contrast reduction than when using an enlarged central main viewing region in combination with only one continuous effect region with a relatively constant additive power (positive dioptric and/or contrast-reducing).

In a preferred embodiment, the microstructures comprise in particular refractive Fresnel structures. In principle, diffractive structures would also be possible. However, refractive Fresnel structures are comparatively easy to manufacture with high quality. The Fresnel structures are particularly preferably provided on a surface of the spectacle lens with a profile height (step height) in the range from about 0.01 mm to, in particular, about 0.2 mm, preferably in a range from about 0.02 mm to, in particular, about 0.2 mm. A step spacing of the Fresnel structure is preferably in the range from about 0.2 mm to about 2 mm, even more preferably in a range from about 0.5 mm to about 1 mm.

In one aspect, the microstructures in the effect region bring about at least partly the contrast reduction. To this end, the microstructures preferably comprise surface roughness, which brings about a dullness of the optical imaging. This dullness then leads to a contrast reduction. The central main viewing region should remain substantially clear, while the contrast reduction is only generated in the effect region (i.e. between the central main viewing region and the peripheral region). This contrast reduction helps to ensure that the mid-peripheral visual range provides no or less stimulus for length growth of the eye. This contrast reduction is particularly effective if the perception (or degree of perception) in the contrast reduction region is at least around 0.5, preferably at least around 0.7. Preferably, the perception due to the contrast reduction is not greater than about 0.9, even more preferably not greater than about 0.8.

Perception is understood here in particular as the factor by which the visual acuity (i.e. visual acuity) is reduced, wherein a visual acuity determined to the value 1 in accordance with DIN 58220 Part 3 is assumed as the reference. Thus, a perception of 0 (<0.1) means substantially complete occlusion and 1 in principle means complete transparency. These properties result in particular when the spectacle lens is arranged in a position with a typical corneal vertex distance (CVD), i.e. in particular with at least one value of the CVD in the range from about 11 mm to about 18 mm, particularly preferably with at least one value of the CVD of about 13 mm or about 14 mm.

As an alternative or in addition to compliance with the ranges of values for perception proposed herein, it may be particularly preferred if the contrast reduction brought about by the microstructure in the effect region leads to a haze value (in particular % haze) according to the ASTM D-1003 standard in the range of not more than about 10, preferably in the range of not more than about 2, and preferably wherein the contrast reduction brought about by the microstructure in the effect region leads to a haze value according to the ASTM D-1003 standard in the range of at least about 0.1, in particular at least about 0.5.

Particularly preferably, in the event of a contrast reduction, the effect region nevertheless has a transmission (in particular a luminous transmittance value in accordance with the ASTM D-1003 standard) of at least 85, even more preferably at least 90. This ensures that the spectacle lens does not completely block (e.g. absorb and/or reflect) the light and thus darken the field of vision even in the event of a contrast reduction, but that the light is only (partially) scattered. This largely preserves the impression of brightness and prevents the pupil from becoming noticeably larger (due to reduced light incidence).

The values for both haze and luminous transmittance in accordance with the ASTM D-1003 standard can be determined or checked using the “haze-gard plus” measuring device from BYK Additives and Instruments, for example.

In the case of a purely dioptric or contrast-reducing effect of the microstructures, this is preferably only provided outside the central main viewing region and possibly outside the peripheral region, i.e. in particular in the effect region. Alternatively, however, microstructures can also be provided in the central main viewing region, in the effect region and possibly in the peripheral region, wherein the positive dioptric additive power and/or the contrast reduction is only achieved in the effect region. However, the microstructures can have a (uniform) dioptric and/or prismatic additive power on the entire spectacle lens (i.e. including the central main viewing region, the effect region and/or, if applicable, the peripheral region).

In a preferred embodiment, the central main viewing region is oval, in particular substantially elliptical, wherein preferably a ratio of the largest to the smallest diameter is in the range of about 1.2 to about 2.5, preferably in a range of about 1.25 to about 2. Particularly preferred is an axis of the largest diameter inclined relative to the vertical of the spectacle lens by an angle in the range of about 5° to about 20°.

In a preferred embodiment, the effect region contains a near section which lies within a segment of the spectacle lens and preferably comprises, i.e. occupies, a segment of the effect region. The optical properties of the segment of the effect region comprised by the near section differ at least partially from the optical properties of the remaining effect region, in particular with regard to their positive dioptric additive power and/or their contrast reduction. Particularly preferably, the segment of the effect region comprised by the near section has substantially no contrast reduction, while preferably the remaining effect region, i.e. the part not comprised by the near section, brings about at least partly (in particular for the most part in terms of area) a contrast reduction.

In a preferred embodiment, the segment of the effect region comprised by the near section has substantially no microstructures. In another preferred embodiment, the segment of the effect region comprised by the near section comprises microlenses which substantially have or cause a common focal point on the eye side. Preferably, a second image is generated by the microlenses, which is superimposed on a first image (sharp for the distance). The result is not only a sharp image of the near object but also a blurred image (from the part that produces the sharp image for the distance). Particularly preferably, the remaining segment of the effect region, i.e. the segment not comprised by the near section, also has microlenses, although these do not have a common focal point. In any case, preferably most of the microlenses in the remaining effect region do not have any (in particular directly) neighbouring microlens(es) with the same focal point. Otherwise, the positive dioptric additive power of each individual microlens in the near section and in the remaining effect region may even be substantially the same. However, while the microlenses do not lead to a common addition effect due to the different positions of the focal points, but produce a blurred image, the microlenses in the near section can contribute to an addition effect, so that the near section is very suitable for the user, especially for reading at shorter distances.

In one aspect, the microlenses in the near section can provide focussing on an optical axis of the spectacle lens extending through the central main viewing region and/or defined by the central main viewing region. In other words, it is preferable if optical axes of the microstructures in the near section intersect at their common focal point. A sharp imaging, i.e. a sharp view, is preferably achieved through the spectacle lens in the entire near section, in particular in the segment of the effect region comprised by the near section. Due to the positive dioptric additive power of the microstructures in the part of the effect region comprised by the near section relative to the central main viewing region, improved near vision is achieved. On the other hand, the microstructures in the remaining effect region (i.e. outside the near section) preferably each have a focal point which lies in particular outside an intersection point of their optical axes.

Preferably, the near section lies within a region which is delimited temporally by a vertical meridian line downwards from the centre of the central main viewing region and nasally by a meridian line twisted nasally by 45°, preferably by 30°, even more preferably by 20° to the vertical downwards from the centre of the central main viewing region. In other words, the near section is preferably located between two imaginary lines, one of which runs vertically downwards (through the effect region) from the centre of the central main viewing region. This imaginary line preferably represents the temporal boundary of the near section. The other imaginary line runs downwards from the centre of the central main viewing region, twisted nasally by the aforementioned angle relative to the vertical. This imaginary line preferably represents the nasal boundary of the near section. The near section does not have to fill the entire area between the two imaginary lines. Preferably, however, it does not extend beyond the two imaginary lines.

When reference is made in this description to the centre of the central main viewing region, this refers in particular to the geometric centre of gravity of the area of the central main viewing region or the centre point of the smallest circle that still completely contains the central main viewing region.

In one aspect, the present invention relates to a spectacle lens, in particular according to one of the preferred embodiments presented in the remainder of this description, comprising:
a spectacle lens body having microstructures (in particular in the form of microlenses, also known as lenslets) with, in particular, a positive dioptric additive power on at least a first surface of the spectacle lens body; and
a protective layer arranged on the spectacle lens body, which protective layer covers the microstructures (e.g. microlenses) at least partially, preferably completely, wherein the protective layer has a refractive index which differs from the refractive index of the spectacle lens body. In this way, the microstructures (e.g. microlenses) provided in particular in the effect region are very efficiently protected from damage and/or soiling.

In this way, the protective layer prevents the microstructures formed in the spectacle lens, i.e. on the first surface of the spectacle lens body (in particular in the form of microlenses with a positive dioptric effect), from being damaged or contaminated during production by subsequent process steps in spectacle lens production and/or also when the spectacle lens is used in spectacles. Due to the difference in refractive index, the microstructures remain optically effective, in particular the microstructure as microlenses can generate a local, positive dioptric additive power. In particular, the protective layer is provided with sufficient optical transparency so as not to impair, too much, the use of the spectacle lens including the protective layer. For this purpose, the protective layer has a largely smooth surface on the side of the protective layer facing away from the microstructures, which in particular does not follow the topography of the microstructures but merely the global curvature of the spectacle lens. This substantially smooth surface of the protective layer is therefore much less sensitive to damage or soiling. Furthermore, this offers the possibility of very easily applying additional layers (e.g. anti-reflective layers, topcoating, hard layers), which could not (easily) be applied to the non-planar surface of the microstructure or could negatively influence its effect.

Preferably, a difference between the refractive index of the protective layer and the refractive index of the spectacle lens body is at least about 0.05, even more preferably at least about 0.1, particularly preferably at least about 0.15, most preferably at least about 0.2. Larger differences have the advantage of a greater effect, while smaller differences have the advantage of a lower reflection coefficient and simpler materials.

As the optical effect of the microlenses depends on the difference in refractive index between the material chosen for the spectacle lens body and that used for the protective layer, the greatest possible difference is advantageous. Conversely, however, a high refractive index can lead to undesirable reflections at the boundary layer between the main body and the cover layer. The strength of the reflection E can be estimated using the known formula for perpendicular incidence:

$$ϵ = {( \frac{{n}_{2} - {n}_{2}}{{n}_{2} + {n}_{2}} )}^{2} \qquad ( 1 )$$

TABLE 1
contains the results for the refractive indices
of some preferred material combinations

| | | | | | | | | | | |
|---|---|---|---|---|---|---|---|---|---|---|
| n₁ | 1.50 | 1.50 | 1.50 | 1.60 | 1.60 | 1.67 | 1.00 | 1.00 | 1.00 | 1.00 |
| n₂ | 1.60 | 1.67 | 1.90 | 1.67 | 1.90 | 1.90 | 1.50 | 1.60 | 1.67 | 1.90 |
| ϵ [%] | 0.10 | 0.29 | 1.38 | 0.05 | 0.73 | 0.42 | 4.00 | 5.33 | 6.30 | 9.63 |

Table 1: Reflection strength for different material combinations and different materials against air (n₁=1.00) as a reference value

In addition to avoiding reflection at this boundary, a low reflection strength at this boundary is particularly preferable in order to avoid multiple or Fabry-Perrot reflections with subsequent layers (e.g. hard coating) or layers of the opposite spectacle lens surface. In order to avoid said multiple or Fabry-Perrot reflections, it is particularly preferable to provide the protective layer-air and spectacle lens body-air interfaces with an anti-reflective layer.

The refractive index combinations of 1.50 with 1.60 or 1.60 with 1.67 have a very low reflectivity. Due to the higher refractive index difference, refractive index combinations of 1.5 with 1.67 have a higher optical effect with well-tolerated reflections. Combinations with 1.90, on the other hand, show quite high reflective strengths.

In particular, the microstructures are designed as microlenses (especially nubs of the spectacle lens body) to image the part of the light that passes through these microlenses (lenslets) in front of the retina in order to counteract the length growth of the eye. For this purpose, the lenslets preferably have a positive dioptric additive power D. For example, an additive power of around 3.5 dpt has been proven. However, other powers (e.g. 2 to 5 dpt) are just as possible and should have a similar effect. The optical effect of the nubs is caused by refraction at the interface between the spectacle lens body and the protective layer in the region of the nubs. With a given defocussing effect D of a nub and the refractive indices no and n_{H} of the protective layer or the spectacle lens body, the radius r of the nub can be determined in the simplest case according to the formula for the optical effect of a refractive surface as follows:

$$r = ( {n}_{H} - {n}_{D} ) / D \qquad ( 2 )$$

If the refractive index of the spectacle lens body is greater than that of the protective layer, convex nubs (positive radius) as seen from the spectacle lens body lead to the desired positive dioptric, i.e. collecting, additive power. In the opposite case (i.e. refractive index of the protective layer is greater than that of the spectacle lens body), concave nubs (“dips”) must be selected for a collecting additive power (negative radius). For a given radius, the height h of the nub and the diameter s of its lateral extent are in the following ratio according to the geometry of circle segments:

$$s = 2 \sqrt{2 \vert r \vert h - {h}^{2}} and respectively h = r - \sqrt{{r}^{2} - {s}^{2} / 4} \qquad ( 3 )$$

Some examples of the resulting nub sizes are summarised in Table 2.

TABLE 2
Examples of dimensions of the nubs for given
additive powers and refractive indices

| D [dpt] | n_{D} | n_{H} | r [mm] | s [mm] | h [μm] | Note |
|---|---|---|---|---|---|---|
| 3.50 | 1.54 | 1.60 | 17.14 | 1.03 | 7.74 | Preferred material |
| | | | | | | combination |
| 3.50 | 1.49 | 1.60 | 31.43 | 1.03 | 4.22 | Protective layer |
| | | | | | | with lower |
| | | | | | | refractive index |
| 3.50 | 1.54 | 1.67 | 37.14 | 1.03 | 3.57 | Spectacle lens |
| | | | | | | body with higher |
| | | | | | | refractive index |
| 3.50 | 1.60 | 1.67 | 20.00 | 1.03 | 6.63 | Both materials |
| | | | | | | with higher |
| | | | | | | refractive index |
| 5.00 | 1.54 | 1.60 | 12.00 | 1.03 | 11.06 | Higher additive |
| | | | | | | power |
| 2.00 | 1.54 | 1.60 | 30.00 | 1.03 | 4.42 | Lower additive |
| | | | | | | power |
| 3.50 | 1.54 | 1.60 | 17.14 | 2.00 | 29.19 | Larger |
| | | | | | | lenslet area |
| 3.50 | 1.54 | 1.60 | 17.14 | 0.50 | 1.82 | Smaller |
| | | | | | | lenslet area |
| 3.50 | 1.60 | 1.50 | −28.57 | 1.03 | −4.64 | Refractive index |
| | | | | | | of the spectacle |
| | | | | | | lens body lower |
| | | | | | | than that of the |
| | | | | | | protective layer, |
| | | | | | | dips instead of nubs |
| | | | | | | in the spectacle |
| | | | | | | lens body |
| 3.50 | 1.00 | 1.50 | 142.86 | 1.03 | 0.93 | for comparison: |
| | | | | | | without protective |
| | | | | | | layer |

The calculations described above only take into account the effects of refraction between the protective layer and the spectacle lens body. This is permissible to a sufficient degree of approximation. If a more precise treatment is required, the refractions at all or some other transitions of the system can also be taken into account. The transitions are in particular air→protective layer, cover layer→spectacle lens body and spectacle lens body→air for structures on the front surface and air→spectacle lens body, spectacle lens body→protective layer and protective layer→air for structures on the rear surface. If additional coatings result in further optically active interfaces, these can also be taken into account. Additionally or alternatively, the divergence or parallelism of the radiation incident on the lens and/or the exact geometric shape of the nubs can also be taken into account. In particular, the following technical optics methods can be used for the calculation: second-order analytical calculation; analytical calculation including higher order; simulation using ray tracing; simulation using wave tracing. The effect of the spectacle lens can be considered in isolation or used at a reference position such as the vertex sphere or a real or fictitious surface in the eye (e.g. retina, back surface of the eye lens, principal plane). Furthermore, not only the radius of spherical sector-shaped nubs or dips can be calculated, but also shapes deviating from spherical surfaces can be determined for the nubs or dips.

To reduce the height of the microstructures, the lenslets can also be designed as Fresnel lenses or diffractive lenses. Simple diffractive structures are more difficult to manufacture due to the smaller structures and more acute angles. When using the first order of diffraction, the height corresponds to the design wavelength in relation to the difference in the refractive indices of the materials of the protective layer and the spectacle lens body. Fresnel structures are typically larger and do not exhibit any relevant interference in their pure form. This can be achieved by designing the structures large enough. Widths between 0.2 mm and 1 mm are suitable. MODs (multi-order diffractive structures) lie in the intermediate range. In contrast to simple diffractive structures, higher diffraction orders are used, wherein different wavelength ranges can have their respective diffraction maximum at different orders. This significantly reduces the colour error.

Preferably, the protective layer has a thickness of at least about 5 μm, more preferably at least about 10 μm, even more preferably at least about 20 μm, particularly preferably at least about 100 μm, most preferably at least about 200 μm. Alternatively or additionally, the protective layer preferably has a thickness of at most about 1 mm, more preferably at most about 0.5 mm, particularly preferably at most about 0.3 mm.

Preferably, the thickness of the coating ensures that all nubs (or dips) can be covered and that the protective layer is optically active in terms of geometric optics. Furthermore, interference phenomena are ideally avoided. It can be assumed that the wavelengths of visible radiation are in the range of 400 nm to 700 nm and the coherence length of natural radiation is in the range of medium wavelengths. This means that the minimum thickness is substantially determined by the height of the nubs or the Fresnel or diffractive structures. A multiple (at least around four to ten times) of the wavelength should be added to the height of the structure. Depending on the geometry of the nubs, layer thicknesses from around 10 μm are therefore particularly preferable. Correspondingly higher layer thicknesses may also be preferred for high structures. In general, it is advantageous to choose higher layer thicknesses in order to be able to more reliably exclude disruptive interference phenomena and to better compensate for any large-area unevenness in the spectacle lens body. Preferred layer thicknesses are therefore in the range from around 30 μm to around 300 μm. Thicker cover layers are not critical for the functioning of the invention, but may have other advantages or disadvantages depending on the material and requirements (e.g. with regard to stability or the overall thickness of the spectacle lens). Furthermore, the actual layer thickness may depend on the materials and manufacturing techniques used, as different materials and manufacturing techniques may be limited or favoured in terms of both maximum and minimum thicknesses.

Preferably, the nub structure (microstructure) at the interface between the spectacle lens body and the protective layer can be produced as described below. The surface of the spectacle lens body opposite this surface can either be given the desired shape during production (e.g. by casting) using a suitable casting mould or subsequently produced using known processes (e.g. grinding and polishing, RGF processes). The protective layer can also serve to protect the microstructure during the machining of the opposite surface. In a preferred embodiment, the protective layer forms the front of the spectacle lens and the spectacle lens body forms the back.

As with conventional spectacle lenses, it is also possible to work with a base curve system. In a system based on the front surfaces, several elements with nubs/dips of different sizes can be created for each individual element (i.e. for each local surface region) of the base curve system with nubs/dips. It is possible here to adjust the size of the nubs/dips of each element of the original system on the basis of the effect region of the respective element or its geometric properties. Alternatively, however, each element of the system can also be provided with equally sized nubs/dips. The two free surfaces of the spectacle lens body and protective layer can be coated with the known layers such as hard coating, anti-reflective coating and topcoat.

In a preferred embodiment, the spectacle lens body is structured and the protective layer is applied. In this procedure, the spectacle lens body is structured, i.e. provided with the microstructures, and then the protective layer is applied. Preferably, the spectacle lens body can be structured directly. In the case of direct structuring, the microstructure is preferably introduced into a preliminary product created in a previous step. This can be done, for example, by turning, milling, laser ablation, lithography, embossing or similar. Alternatively, the structuring of the spectacle lens body can also take place during the production of the spectacle lens body. In this case, the microstructures are introduced during the production of the spectacle lens body or a preliminary product. In the case of spectacle lens bodies made of organic materials, this is typically done by using suitably structured moulds and casting processes during solidification. While liquid, already polymerised material can also be used in the case of thermoplastics, this is typically only done during polymerisation in the case of thermosets.

The subsequent application of the protective layer can be carried out in particular by spinning and/or dipcoating. Dipcoating and spincoating can be used to apply layers that are typically up to 10 μm thick (dipcoating) or 40 μm thick (spincoating). This is sufficient for many embodiments (especially in conjunction with a reduction in the height of the structures). The higher thicknesses can be achieved in particular by selecting materials (especially acrylates such as Transhade by Tokuyama) with a higher viscosity and by dispensing with dilution with solvent and a suitable choice of process parameters and methods (e.g. rotation speed, temperature, duration, multiple coating).

Alternatively, the protective layer can also be applied by integral casting. For embodiments with higher additive powers or lower refractive index differences between the materials and without height-reducing measures, the layer thicknesses or surface qualities that can be achieved by spinning and/or dipcoating may not be sufficient. With the technique of integral casting, significantly higher thicknesses of the surface layer can be achieved. In addition, the use of the casting mould can improve the quality of the surface and ensure that the surface is actually (locally) flat. Depending on the material, this can no longer be reliably ensured with conventional coating methods with higher nubs or larger dips, depending on the configuration.

Spectacle lenses according to the invention can be manufactured particularly advantageously using the transfer layer method. A particularly preferred method is described in detail in DE 10 2012 023 025 A1, for example. This method is particularly advantageous in conjunction with the spectacle lenses described here because the thickness of the protective layer, which is usually less than that of the spectacle lens body, can significantly reduce both the service life of the expensive structured casting moulds and the casting shrinkage of the material to be structured. Furthermore, the transfer layer method is analogous to the integral casting method in that cover layers with greater thicknesses and possibly better surface quality can be produced than by spinning and/or dipcoating.

It is particularly easy to incorporate the microstructures into casting moulds (for the spectacle lens body or the transfer layer) made of metal (in particular nickel-coated steel) (for example by turning, milling, laser ablation and lithography). Castings are possible with such casting moulds. However, they have disadvantages when it comes to cleaning after casting and with regard to the mechanical and chemical stability of the formed structure. Casting moulds made of special crown glass (e.g. hardened crown glass type CH-W 0991 (S-3) from Barberini GmbH based on Schott materials) have proven to be particularly suitable in terms of cleaning and stability. These can be structured, for example, by turning, milling, laser ablation and lithography. Due to the brittleness of the material, however, this can be difficult and require complex processes. Structured casting moulds made of crown glass can usually be produced more cost-effectively and/or with better quality by imprinting the structure. Metallic structured stamps can be used for this purpose, for example. The glass material can be heated and thus made viscous for embossing.

Specific examples of preferred materials for the spectacle lens body and for the protective layer are given below. The following materials are particularly suitable for the spectacle lens body, i.e. the main component of the spectacle lens, which is obtained in particular from a spectacle lens blank:
Perfalit 1.5
   Chemical name: Polyethylene glycol bisallyl carbonate
   The base material is CR 39 (Columbia Resin 39) from PPG.
   Refractive index 1.5; Abbe number 58
   Thermoset
PCM 1.54 (photochrome)
   Chemical name: Copolymers containing polyethylene glycol dimethacrylate, among others
   Refractive index 1.54; Abbe number 43
   Thermoset
Polycarbonate
   Refractive index 1.59; Abbe number 29
   Absolutely unbreakable! (sports and children's areas)
   Poor solvent resistance (alcohol, acetone)
   Thermoplastic
Perfalit 1.6
   Chemical name: Polythiourethane
   Refractive index 1.60; Abbe number 41
   Thermoset
Perfalit 1.67
   Chemical name: Polythiourethane
   Refractive index 1.67; Abbe number 32
   Thermoset
Perfalit/Cosmolit 1.74
   Chemical name: Polyapisulfide
   Calculation index 1.74; Abbe number about 32
   Thermoset
PMMA
Mineral glasses

In particular in combination with one or more of the above-mentioned preferred materials of the spectacle lens body, one or more of the following materials are preferably used for the protective layer:
TS56T from Tokuyama:
This coating with a refractive index of 1.49 is used for conventional spectacle lenses, preferably for Perfalit 1.5. A dipping process preferably produces thicknesses of around 2.2 μm.
IM-9200 from SDC Technologies:
This coating has an optical power of between 1.585 and 1.605 and is preferably applied to Perfalit 1.6 and 1.67 after surface activation for conventional spectacle lenses. Preferably, thicknesses of around 2.8 μm are achieved by dipping processes. Variations from 1.5 μm to 3.2 μm are possible.
Transhade from Tokuyama:
This is preferably a photochromic coating system. Preferably, a primer (Transhade-SC-P) is applied to the spectacle lens body (Perfalit 1.6 or 1.67) as an adhesion promoter and then the photochromic photoresist (Transhade-SC-L4 Brown or Gray) with a refractive index in the range from 1.50 to 1.55 is applied and preferably covered with a hard coating layer. Spincoating is preferably used to achieve thicknesses between 30 μm and 50 μm. Typical thicknesses are around 39 μm. In addition, integral casting processes can also be used to achieve thicknesses of over 200 μm. This coating is also available without photochromic dyes and can be cured both thermally and with UV.
Hi Guard 1080 from PPG and products from Tokuyama
These coatings could be used as an alternative to TS56T (3) from Tokuyama for application on Perfalit 1.5.

It is particularly preferable to apply a protective layer with the lowest possible refractive index (low refractive index n_{S}) to lenses with the highest possible refractive index (high refractive index of the spectacle lens body n_{K} in particular including the microstructure). This achieves the highest possible refractive index jump. Preferred combinations are, for example, n_{S}=1.5 to n_{K}=1.6 or to n_{K}=1.67 or to n_{K}=1.74, etc., but also n_{S}=1.6 to n_{K}=1.67 or to n_{K}=1.74, etc., but also n_{S}=1.67 to n_{K}=1.74, etc. Combinations with an even higher difference in the refractive index, in particular at least 0.2 or higher, are particularly preferred. In general, however, the refractive index of the protective layer can also be higher than the refractive index of the spectacle lens body. The geometry of the microstructures (e.g. microlenses) will then be inversely shaped for the same effect.

Materials for casting moulds are therefore particularly preferred:
Crown glass (for example, tempered crown glass type CH-W 0991 (S-3) from Barberini GmbH based on Schott materials)
Quartz glass (“fused silica”)
Metals (e.g. steel, nickel, nickel alloys)
Plastics (e.g. polycarbonate (PC), polyamide (PA), polymethyl methacrylate (PMMA))

As materials for carrier substrates, the materials mentioned for the spectacle lens body and/or the materials mentioned for casting moulds are therefore particularly preferred.

A preferred material combination is: main body made of Perfalit 1.6 combined with the cover or transfer layer made of Transshade, a casting mould made of crown glass CH-W 0991 and, if a transfer layer process is used, with Perfalit 1.5 as the carrier substrate. In principle, a wide variety of materials are possible, such as plastics, glasses or metals, both individually and in combination. The individual materials can be layered and/or structured on the surface.

### BRIEF DESCRIPTION OF THE DRAWINGS

In the following, the invention is further described with reference to the accompanying drawings by means of preferred embodiments. The drawings show:

FIG. 1A to 1C schematic plan views of exemplary spectacle lenses;

FIG. 2A to 2C schematic representations of an exemplary effect distribution;

FIGS. 3A and 3B schematic representations of a further exemplary effect distribution;

FIGS. 4A and 4B schematic plan views of exemplary spectacle lenses with a near section;

FIGS. 5A and 5B schematic representations of different arrangements of microlenses;

FIGS. 6A and 6B schematic representations of the cross-section of spectacle lenses with protected microlenses in an effect region between a central main viewing region and a peripheral region according to preferred embodiments of the present invention;

### DETAILED DESCRIPTION

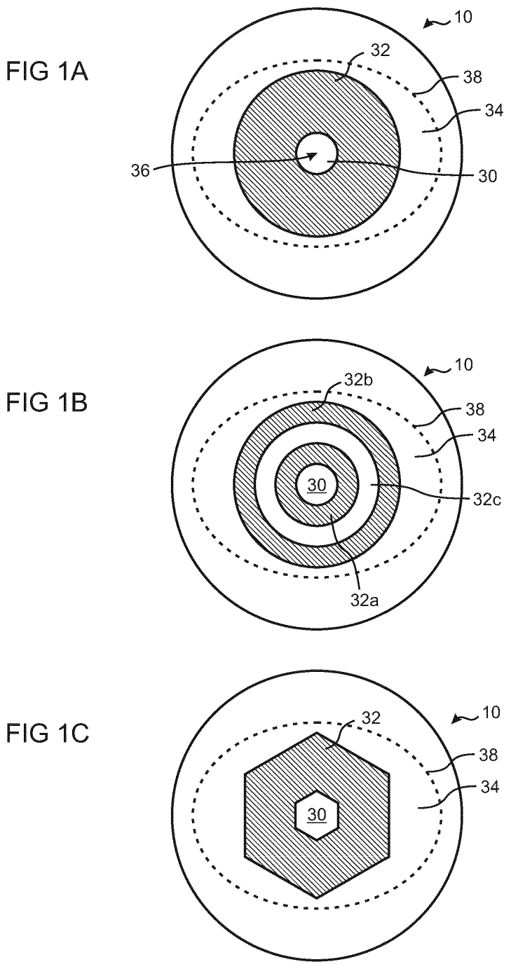

FIG. 1A shows a plan view of an exemplary spectacle lens 10. In this example, the spectacle lens is initially shown as a tubular spectacle lens (before the rim). This tubular lens can then be fitted into a corresponding frame, for example along an edge 38, by edge grinding.

As shown in FIG. 1A, the spectacle lens 10 comprises a central main viewing region 30 with a substantially constant optical power. This central main viewing region 30 is positioned in front of the respective eye of the spectacle wearer (user) by suitably centring the spectacle lens such that, when looking in a main viewing direction, the spectacle wearer looks substantially in the region of a centre 36 of the central main viewing region 30. The dioptric power and preferably all refractive errors of the user's eye to be corrected are corrected as well as possible by the central main viewing region 30. This ensures that the user with this spectacle lens has foveal sharp vision in the main direction of gaze.

In addition, the spectacle lens comprises an effect region 32 around the central main viewing region 30, wherein the effect region 32 at least partially has microstructures, for example in the form of microlenses (lenslets). These microstructures bring about an at least partially higher optical power (positive dioptric additive power) in the effect region 32 than the optical power in the central main viewing region 30 and/or at least partially a contrast reduction. In particular, in the case of a positive dioptric additive power in the effect region 32, the mid-peripheral visual range is imaged slightly in front of the retina of the corresponding eye of the spectacle wearer with sharp vision in the central region (foveal vision). This suppresses length growth of the eye, which leads to a reduction in the progression of a myopic property of the eye and thus to better wearing comfort for the spectacle lens in the long term.

Lastly, the spectacle lens in this variant comprises a peripheral region 34 outside the effect region 32 with a substantially constant optical power. Particularly preferably, the substantially constant optical power in the peripheral region 34 substantially corresponds to the substantially constant optical power in the central main viewing region 30. Thus—assuming an substantially approximately isotropic eye length—the distant peripheral visual range is again at least approximately sharply imaged on the retina of the corresponding eye. On the one hand, this creates a pleasant visual sensation with a fairly wide field of vision and also increases safety when wearing the spectacle lens, as peripheral movements and therefore possible obstacles and dangers can be recognised earlier and more reliably by the wearer. Overall, this in turn contributes to better wearing comfort in the long term.

FIG. 1B shows a schematic plan view of a further exemplary spectacle lens 10. In contrast to the example in FIG. 1A, the effect region 32 here is not continuously covered with a positive dioptric power. Instead, the effect region 32 comprises an inner effect region 32a and an outer effect region 32b, which are radially separated from each other by an annular intermediate region 32c. Preferably, the positive dioptric power in the intermediate region 32c is less than in the inner effective region 32a and than in the outer effective region 32b. On a line from the central region towards the periphery, the positive dioptric power in the intermediate region 32c thus preferably passes through a local minimum. Particularly preferably, the intermediate region 32c has at least partially or for the most part substantially no dioptric power. The ring width of the (substantially power-free) intermediate region 32c is preferably in the range from about 5 mm to about 10 mm.

In the embodiment shown in FIG. 1B, the effect region 32 comprises two annular effect regions 32a and 32b, which are separated from each other by an annular intermediate region 32c. In other embodiments, however, there may also be more (e.g. three) effect regions, which are each separated from one another by intermediate regions (e.g. two), wherein the intermediate regions in each case are free from the positive dioptric additive power or contrast reduction, or have a correspondingly lower power than the annular effect regions separated from one another.

In the schematic, exemplary embodiments of FIGS. 1A and 1B, the central main viewing region 30 and, if applicable, the intermediate region 32c as well as the effect region 32 (or the inner 32a and the outer effect region 32b) are shown in a circular shape. For example, the effect region has substantially the same radial cross-sectional length along all radial cross-sections, i.e. the same length between the respective inner and outer edges of the effect region 32. Preferably, the effect region 32 has substantially the same course of dioptric power and/or contrast reduction in all radial cross-sections between the respective inner edge and the respective outer edge. In other words, in this variant, the dioptric power and/or the contrast reduction do/does not change significantly along the annular course of the effect region 32.

However, this is not necessarily the case. These regions can also have other shapes (e.g. oval). These regions also do not necessarily have to be concentric to each other, even if this can be particularly advantageous for some universal applications. An example of an alternative shape of the central main viewing region 30 and the effect region 32 in the form of (in this case concentric) hexagons is shown in FIG. 1C.

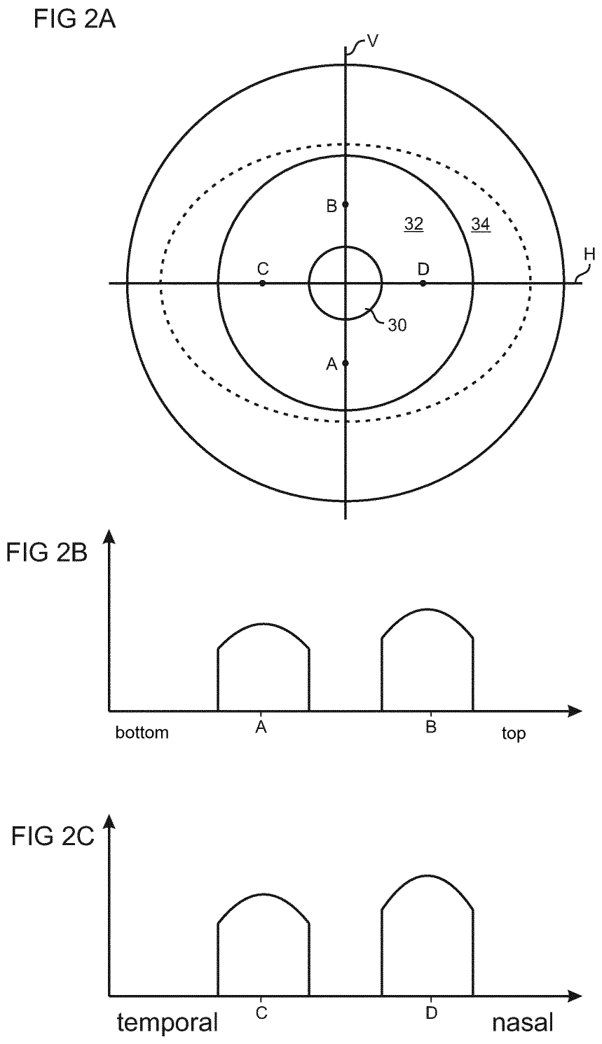

According to the preferred embodiment shown in FIG. 2A to 2C, the optical power brought about by the microstructures along a horizontal meridian H of the spectacle lens through a centre of the central main viewing region has a temporal maximum at a point C, which lies in a region in which the meridian intersects the effect region temporally from the central main viewing region. In addition, the optical power brought about by the microstructures along the horizontal meridian H has a nasal maximum at a point D, which lies in a region where the meridian intersects the effect region nasally from the central main viewing region. FIG. 2C schematically shows the course of the positive dioptric additive power along the horizontal meridian H. The nasal maximum is greater than the temporal maximum, preferably by about 0.5 dpt to about 1 dpt greater. It has been found that this asymmetry in the horizontal course of the positive dioptric additive power is particularly efficient and often improves long-term wearing comfort. This could be explained by the fact that the eye length to the retina in the region temporal to the foveal region is often somewhat smaller than at the same distance nasal to the foveal region.

Furthermore, in the preferred embodiment shown, the optical power brought about by the microstructures along a vertical meridian V of the spectacle lens through a centre of the central main viewing region has a lower maximum at a point A, which lies in a region in which the meridian intersects the effect region below the central main viewing region. Furthermore, the optical power brought about by the microstructures along the vertical meridian V has an upper maximum at a point B, which lies in a region in which the meridian intersects the effect region above the central main viewing region. 2B schematically shows the course of the positive dioptric additive power along the vertical meridian H. The upper maximum is greater than the lower maximum, preferably by about 0.5 dpt to about 1 dpt greater. It was found that this asymmetry in the vertical course of the positive dioptric additive power is particularly efficient and often improves long-term wearing comfort. This could be explained by the fact that the eye length to the retina in the region below the foveal region is often somewhat smaller than at the same distance above the foveal region.

However, particularly preferably, the values of the nasal and/or temporal and/or upper and/or lower maximum can also be individually selected. A more precise course of the positive dioptric additive power in the effect region (in particular along the horizontal and/or vertical meridian) is particularly preferably customised.

Even if a peripheral region 34 with substantially constant optical power is shown schematically in FIG. 2A to 2C, the aspect of taking individual peripheral eye lengths into account is not limited to spectacle lenses with such a peripheral region. Rather, the effect region can also extend to the peripheral edge of the spectacle lens without the need for a peripheral region with a substantially constant optical power similar to the central main viewing region to be present outside. Rather, in this aspect, the spectacle lens preferably produces a focal point position in the entire region outside the central main viewing region, which is substantially the same distance in front of the retina of the corresponding eye.

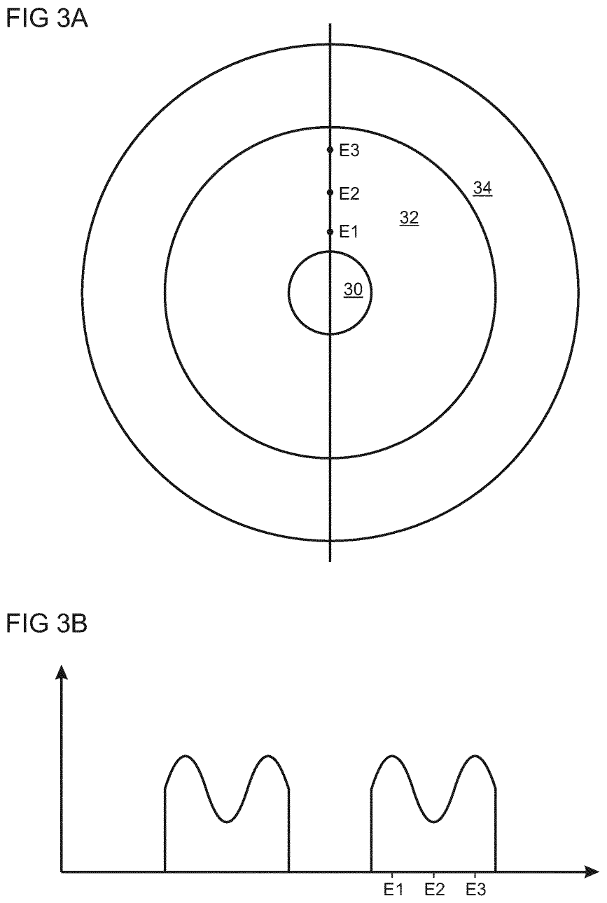

FIGS. 3A and 3B illustrate a further preferred embodiment of a slightly more complex distribution of the positive dioptric additive power. FIG. 3A shows a plan view of the spectacle lens, while FIG. 3B shows a progression of the positive dioptric additive power along the vertical meridian V. Here, the optical power brought about by the microstructures varies along at least one meridian (in this case at least the vertical meridian V) of the spectacle lens 10 through a centre 36 of the central main viewing region 30 by at least about 10%, preferably at least about 25%, even more preferably at least about 50% of the maximum absolute value of the optical power brought about by the microstructures.

Such a course can be customised by several individual measurements of a peripheral eye length and/or peripheral refraction of the eye (in particular along the corresponding meridian). For this purpose, the eye can be measured with a device that can measure or derive central and peripheral biometric data (e.g. an optical biometer, or the DNEye @Scanner 2 from Rodenstock). In particular, the central and peripheral eye length and/or the refraction of the eye can be determined objectively and/or subjectively, centrally and/or peripherally as biometric data. The peripheral data can be measured nasally and/or temporally and/or superiorly (light incidence from above) and/or inferiorly (light incidence from below). The eccentricity of the peripheral measurement can lie in particular in the range from 5° to 40°, preferably in the range from about 10° to about 20°. The measurement can also be carried out at several eccentricities in order to obtain an individual curve

In the embodiment shown in FIGS. 3A and 3B, the peripheral eye length is preferably taken into account individually for at least three eccentricities E1, E2 and E3. This data is used to adjust the optical power of the microstructures locally, depending on the local eye length and/or refraction. The eccentricities can be expressed in eye coordinates as the angle of incidence of light θ relative to a central, foveal light beam, preferably via x=(CVD+d)*tan(B) into corresponding radial distances x of the peripheral light transmission points through the spectacle lens from the central light transmission point in lens coordinates, wherein “CVD” denotes the corneal vertex distance and “d” the distance from the cornea to the entrance pupil. For example, d=3 mm can be a good general approximation. Exemplary values for x (in mm) with different CVD and different angles of incidence of light θ are

| CVD | 5° | 10° | 15° | 20° | 25° | 30° | 35° |
|---|---|---|---|---|---|---|---|
| 10 mm | 1.14 | 2.29 | 3.48 | 4.73 | 6.06 | 7.51 | 9.10 |
| 12 mm | 1.31 | 2.64 | 4.02 | 5.46 | 6.99 | 8.66 | 10.50 |
| 15 mm | 1.57 | 3.17 | 4.82 | 6.55 | 8.39 | 10.39 | 12.60 |

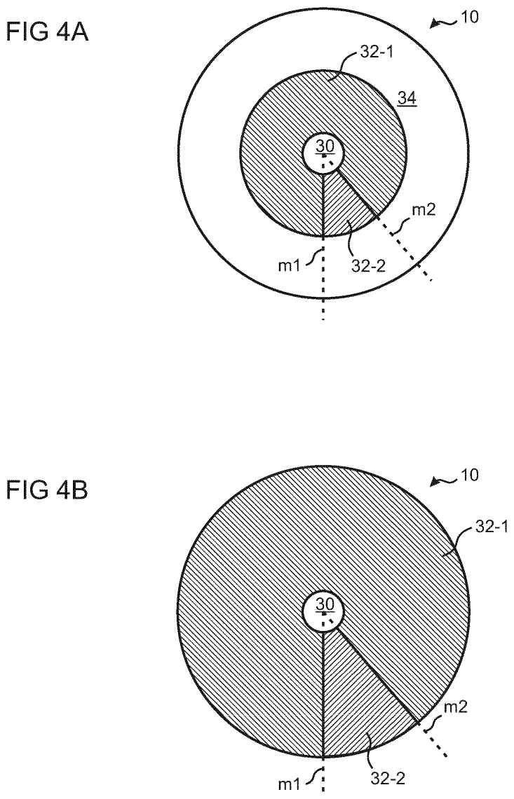

In a preferred embodiment shown in FIG. 4A, the effect region 32 includes a near section 32-2 which lies within a segment of the spectacle lens and comprises a segment of the effect region 32 which is delimited temporally by a vertical meridian line m1 downwards from the centre of the central main viewing region 30 and nasally in this case by a meridian line m2 rotated nasally by about 30° to the vertical downwards from the centre of the central main viewing region. In this case, the optical properties of the segment of the effect region comprised by the near section 32-2 differ at least in part from the optical properties of the remaining effect region 32-1, in particular with regard to their positive dioptric additive power and/or their contrast reduction. Both the near section 32-2 and the remaining effect region 32-1 can have microlenses (lenslets) which, viewed individually, could even be comparable in terms of the value of their positive dioptric additive power. Preferably, however, they are characteristically different at least in their axial orientation. While the microlenses in the remaining effect region 32-1 do not define a common focal point, for example, the microlenses in the near section can be arranged and formed in such a way that they at least partially form a common focal point on the eye side.

While the embodiment of FIG. 4A schematically depicts a peripheral region 34 with a substantially constant effect (i.e. in particular substantially without a positive dioptric additive power), it is not necessary to provide such a peripheral section, in particular for this aspect, i.e. when using a near section. An otherwise analogue variant without a peripheral section is shown schematically in FIG. 4B.

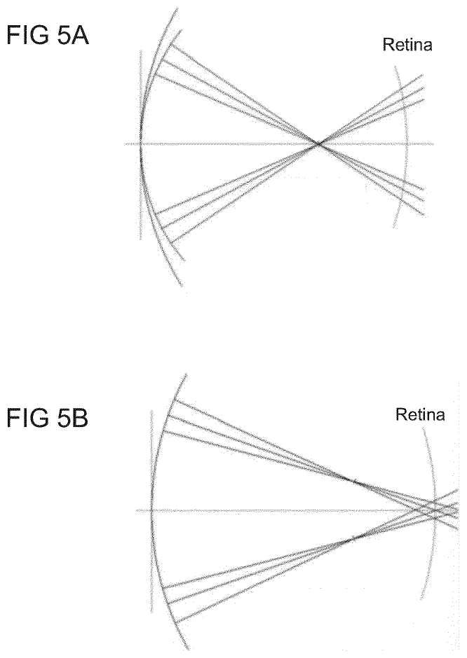

FIGS. 5A and 5B schematically contrast exemplary differences in the constellations of such microlenses for the near section 32-2 in FIG. 5A and for the remaining effect region 32-1 in FIG. 5B. While in a coaxial orientation according to FIG. 5A all microlenses form a common focal point in front of the retina, in the non-coaxial orientation according to FIG. 5B the optical axes of the microlenses intersect on the retina, while they each form a focal point in front of the retina.

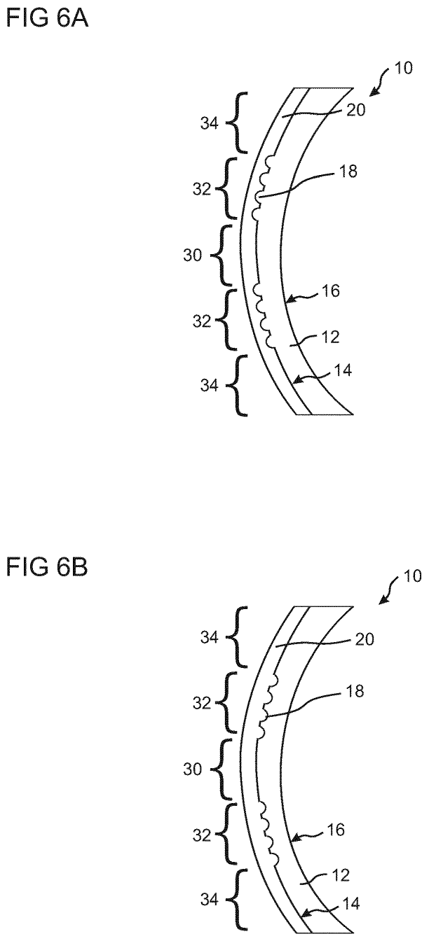

FIGS. 6A and 6B illustrate examples of spectacle lenses 10 with different protected microstructures in the form of microlenses 18. In the embodiments illustrated in FIGS. 6A and 6B, the microlenses 18 are exemplarily provided or shown only within the effect region 32. With regard to their effects and (alternative) distribution over the spectacle lens, in particular over the central main viewing region 30, the effect region 32 and the peripheral region, reference is preferably made to the other explanations in this description.

Preferably, a spectacle lens body 12 has a front surface 14 and a rear surface 16 (eye-side surface). In the exemplary embodiments shown, microlenses 18 are formed on the front surface 14 in each case. In addition, in the preferred embodiments shown, the spectacle lens 10 has a protective layer 20 on the front surface 14 of the spectacle lens body 12, which in particular completely covers the microlenses 18. The protective layer has a refractive index which differs from the refractive index of the spectacle lens body, preferably by at least about 0.05. The refractive index of the protective layer 20 is particularly preferably lower than the refractive index of the spectacle lens body 12. Such a constellation for microlenses with a positive dioptric additive power is shown in FIG. 6A. Here, the microlenses form elevations on the front surface of the spectacle lens body 12. The additional optical power of the microlenses is brought about in particular by their (more) curved surface and a refractive index transition between the spectacle lens body and the protective layer. FIG. 6B, on the other hand, shows an embodiment in which, for a positive dioptric additive power of the microlenses 18 with a refractive index of the protective layer 20 which is greater than the refractive index of the spectacle lens body 12, the microlenses are formed as indentations in the spectacle lens body 12.

The illustration of the microlenses 18 should be regarded as purely schematic. In particular, the respective microlenses 18 are not shown to scale. Typically, the microlenses 18 are substantially smaller compared to the spectacle lens body 12. Typical dimensions of preferred microlenses 18 are preferably around 0.5 to 50 μm in the axial direction (i.e. in the thickness direction of the spectacle lens) and around 0.3 to 3 mm in the lateral direction. Radii of curvature of the surfaces of the protected microlenses are typically in the range of about 5 to 50 mm. In particular, the radii of curvature of protected microlenses are regularly smaller than the radii of curvature of corresponding unprotected microlenses. Like the microlenses 18, the protective layer 20 is not shown to scale in FIGS. 6A and 6B. Preferably, the protective layer 20 is substantially thinner than the spectacle lens body 12. Thus, the protective layer 20 is preferably thinner than about 1 mm, more preferably no thicker than about 0.5 mm, even more preferably no thicker than about 0.2 mm. In some preferred embodiments, the protective layer is no thicker than about 0.1 mm or even no thicker than about 50 μm. However, the protective layer is preferably at least thick enough to cover the microlenses 18 on the front surface 14 (first surface of the spectacle lens body) and thus protect them from damage and contamination.

1-26. (canceled)

27. A spectacle lens which comprises:
a central main viewing region, with substantially constant optical power; and
an effect region around the central main viewing region, wherein the effect region has microstructures at least in part, said microstructures in the effect region bringing about
an at least partially higher optical power than the optical power in the central main viewing region and/or
at least partly a contrast reduction.

28. The spectacle lens according to claim 27, which additionally comprises:
a peripheral region outside the effect region with a substantially constant optical power.

29. The spectacle lens according to claim 28, wherein the substantially constant optical power in the peripheral region substantially corresponds to the substantially constant optical power in the central main viewing region.

30. The spectacle lens according to claim 28, wherein the peripheral region lies outside a circular area with a radius of at least about 20 mm, preferably at least about 25 mm, more preferably at least about 30 mm, even more preferably at least about 35 mm, most preferably at least about 40 mm; and/or wherein the effect region lies within a circular area with a radius of at most about 45 mm, preferably at most about 40 mm, particularly preferably at most about 35 mm, even more preferably at most about 30 mm, most preferably at most about 25 mm.

31. The spectacle lens according to claim 27, wherein the microstructures comprise microlenses.

32. The spectacle lens according to claim 27, wherein the optical power brought about by the microstructures in the effect region is at least about 1 dpt, preferably at least about 2 dpt, even more preferably at least about 3 dpt higher than the optical power in the central main viewing region; and/or wherein the optical power brought about by the microstructures in the effect region is at most about 10 dpt, preferably at most about 5 dpt, even more preferably at most about 4 dpt higher than the optical power in the central main viewing region.

33. The spectacle lens according to claim 27, wherein the optical power brought about by the microstructures varies along at least one meridian of the spectacle lens through a centre of the central main viewing region by at least about 10%, preferably at least about 25%, even more preferably at least about 50% of the maximum absolute value of the optical power brought about by the microstructures.

34. The spectacle lens according to claim 27, wherein the optical power brought about by the microstructures along a horizontal meridian of the spectacle lens through a centre of the central main viewing region has a temporal maximum in a region in which the meridian intersects the effect region temporally from the central main viewing region and a nasal maximum in a region in which the meridian intersects the effect region nasally from the central main viewing region, such that the nasal maximum is greater than the temporal maximum, preferably greater by about 0.5 dpt to about 1 dpt.

35. The spectacle lens according to claim 27, wherein the optical power brought about by the microstructures along a vertical meridian of the spectacle lens through a centre of the central main viewing region has a lower maximum in a region in which the meridian intersects the effect region below the central main viewing region and an upper maximum in a region in which the meridian intersects the effect region above the central main viewing region, such that the upper maximum is greater than the lower maximum, preferably greater by about 0.5 dpt to about 1 dpt.

36. The spectacle lens according to claim 27, wherein the effect region comprises:
at least one inner effect region, preferably directly adjacent to the central main viewing region, with microstructures which bring about the optical power that is at least partially higher than the optical power in the central main viewing region and/or the contrast reduction;
at least one outer effect region with microstructures which bring about the optical power that is at least partially higher than the optical power in the central main viewing region and/or the contrast reduction; and
at least one intermediate region without microstructures between the inner and the outer effect region or with microstructures which produce a lower optical power or a lower contrast reduction than the microstructures in the inner and in the outer effect region.

37. The spectacle lens according to claim 27, wherein the central main viewing region comprises a circular area having a radius of at least about 3 mm, preferably at least about 5 mm, more preferably at least about 8 mm; and/or wherein the central main viewing region lies within a circular area having a radius of at most about 25 mm, preferably at most about 20 mm, even more preferably at most about 15 mm, most preferably at most about 10 mm.

38. The spectacle lens according to claim 27, wherein the central main viewing region is oval, in particular substantially elliptical, and a ratio of the largest to the smallest diameter is in the range of about 1.2 to about 2.5, preferably in a range of about 1.25 to about 2.

39. The spectacle lens according to claim 38, wherein an axis of the largest diameter relative to the vertical of the spectacle lens is inclined by an angle in the range of about 5° to about 20°.

40. The spectacle lens according to claim 27, wherein the contrast reduction brought about by the microstructures in the effect region leads to a perception in the range of at least about 0.5, preferably in the range of at least about 0.7, and wherein the perception due to the contrast reduction is preferably not greater than about 0.9, even more preferably not greater than about 0.8.

41. The spectacle lens according to claim 27, wherein the effect region comprises a near section which lies within a segment of the spectacle lens and comprises/occupies a segment of the effect region,
wherein the optical properties of the segment of the effect region comprised by the near section differ at least partially from the optical properties of the remaining effect region.

42. The spectacle lens according to claim 41, wherein the segment of the effect region comprised by the near section has substantially no contrast reduction.

43. The spectacle lens according to claim 41, wherein the segment of the effect region comprised by the near section has substantially no microstructures.

44. The spectacle lens according to claim 41, wherein the segment of the effect region comprised by the near section comprises microlenses which have substantially a common focal point on the eye side.

45. The spectacle lens according to claim 44, wherein the microstructures in the remaining effect region comprise microlenses which do not have a common focal point.

46. The spectacle lens according to claim 41, wherein the near section lies within a region which is delimited temporally by a vertical meridian line (m1) downwards from the centre of the central main viewing region and nasally by a meridian line (m2) rotated by 45°, preferably by 30°, even more preferably by 20° to the vertical downwards from the centre of the central main viewing region.

47. The spectacle lens according to claim 27, comprising:
a spectacle lens body having microstructures with a positive dioptric additive power on at least a first surface of the spectacle lens body; and
a protective layer arranged on the spectacle lens body, which protective layer at least partially covers the microstructures, wherein the protective layer has a refractive index which differs from the refractive index of the spectacle lens body.

48. The spectacle lens according to claim 47, wherein a difference between the refractive index of the protective layer and the refractive index of the spectacle lens body is at least about 0.05, preferably at least about 0.1, even more preferably at least about 0.15, most preferably at least about 0.2.

49. The spectacle lens according to claim 47, wherein the protective layer has a thickness of at least about 5 μm, preferably at least about 10 μm, further preferably at least about 20 μm, particularly preferably at least about 100 μm, most preferably at least about 200 μm; and/or wherein the protective layer has a thickness of at most about 1 mm, preferably at most about 0.5 mm, particularly preferably at most about 0.3 mm.

50. A method for individually calculating or producing a spectacle lens according to claim 27 for an eye of a user, said method comprising:
providing user data that define at least one central eye length and at least one peripheral eye length of the eye;
determining a value of a target additive power from a value of a baseline additive power and the difference of the central eye length and the at least one peripheral eye length; and
calculating or producing the spectacle lens in such a way that the microstructures in the effect region at least partially bring about an optical power higher by the target additive power than the optical power in the central main viewing region.

51. The method according to claim 50, wherein the user data define a plurality of peripheral eye lengths for at least partially horizontally and/or vertically different light incidence directions, and wherein the method comprises:
determining a respective value of the target additive power for each of the light incidence directions on the basis of the value of the baseline additive power and the respective difference of the central eye length and the respective peripheral eye length;
determining a point of light transmission through the spectacle lens for each of the light incidence directions; and
calculating or producing the spectacle lens in such a way that the microstructures in the light transmission points bring about an optical power that is higher than the optical power in the central main viewing region by the respective target additive power.

52. A method for producing a spectacle lens according to claim 27, said method comprising:
providing microstructures in the form of microlenses with a dioptric additive power on at least a first surface of a spectacle lens body; and
applying at least one protective layer to the spectacle lens body in such a way that said protective layer at least partially covers the microstructures, wherein the protective layer has a refractive index which differs from the refractive index of the spectacle lens body.
